(19) United States
(12) Patent Application Publication
(10) Pub. No.: US 2014/0020024 A1
(43) Pub. Date: Jan. 16, 2014

(54) INTUITIVE IMAGE-BASED PROGRAM GUIDE FOR CONTROLLING DISPLAY DEVICE SUCH AS A TELEVISION

(71) Applicants: Aravind Babu Asam, San Diego, CA (US); Jonathan Paul Gaiser, San Diego, CA (US); John D. Smith, Fallbrook, CA (US); Tanmay Agnihotri, San Diego, CA (US); Dongwook Kim, San Diego, CA (US); Neha Sindavala Karnam, San Diego, CA (US)

(72) Inventors: Aravind Babu Asam, San Diego, CA (US); Jonathan Paul Gaiser, San Diego, CA (US); John D. Smith, Fallbrook, CA (US); Tanmay Agnihotri, San Diego, CA (US); Dongwook Kim, San Diego, CA (US); Neha Sindavala Karnam, San Diego, CA (US)

(73) Assignee: SONY CORPORATION, Tokyo (JP)

(21) Appl. No.: 13/606,245

(22) Filed: Sep. 7, 2012

Related U.S. Application Data
(60) Provisional application No. 61/671,890, filed on Jul. 16, 2012.

(51) Int. Cl. H04N 21/482

(52) U.S. Cl. 725/41

(57) ABSTRACT

A control device such as a tablet computer presents a scrollable image-based program guide (IBPG) on a display that a user can swipe to cause the device to command a display device to present an audio video (AV) program represented by the image. The IBPG is a subset of an electronic program guide (EPG) from a TV signal provider and is populated using user history and favorites information and social networking site history and favorites information. Sizes of the images may vary depending on the information.

### I. FIELD OF THE INVENTION

The present application relates generally image-based program guides for controlling display devices such as televisions.

### II. BACKGROUND OF THE INVENTION

Modern TVs such as the Sony Bravia (trademark) present native user interfaces (UI) to allow viewers to select an audio video (AV) input source, to launch non-broadcast TV applications such as video telephone applications (e.g., Skype), and so on. As understood herein, one of the most-used application is the electronic program guide (EPG). Originally presented on a TV display in list format, contemporary EPGs may also include interactive features that augment the list.

As understood herein, people tend to react more intuitively and naturally to visible, graphic cues regarding underlying content, whereas existing EPGs present mostly alpha-numeric program lists. Present principles further understand that EPGs typically list hundreds of channels and programs, most of which the typical viewer will never have any desire to see, yet the viewer must scroll through these otherwise uninteresting channels to locate programs of interest.

### SUMMARY OF THE INVENTION

Accordingly, a device includes a display, a processor controlling the display to present an image-based program guide (IBPG) on the display, and a computer readable storage medium accessible to the processor and bearing instructions executable by the processor to cause the processor to generate a channel list by testing channels in an electronic program guide (EPG) from a TV signal provider to determine whether channels in the EPG are identified in a local favorite's list. Responsive to a determination that a channel in the EPG is in the local favorite's list, a favorites weight is applied to the channel. Also, responsive to a determination that a channel in the EPG is present in a local history list of previously viewed channels, a history weight is applied to the channel. Moreover, responsive to a determination that a channel in the EPG is in a favorite's list of a social networking friend affiliated with a user of the device, a friend's favorite weight is applied to the channel, while responsive to a determination that a channel in the EPG is present in a history list of previously viewed channels of a social networking friend affiliated with a user of the device, a friend's history weight is applied to the channel. The channel list is established based on the weights and is a subset of less than all of the channels on the EPG. For each channel, a respective photograph-based image is established and the images are arranged in the IBPG, with each image being selectable to cause an AV program associated with the respective channel to be presented on a display device.

In some embodiments the device is a control device different from the display device, with the control device communicating wirelessly with the display device. If desired, a first image has a first size and a second image has a second size different from the first size, and the sizes are established based at least in part on one or more of the weights.

In example implementations the images of the IBPG scroll across the display automatically. The display may be a touch screen display and the processor can cause the images of the IBPG to scroll across the display responsive to a determination that a person has made a motion against the display in a first linear dimension. In specific embodiments the processor causes a command to be sent to a display device to present an AV program affiliated with a first image of the IBPG responsive to a determination that a person has made a motion against the display in an area occupied by the first image in a second linear dimension different from the first linear dimension. Also, the processor can cause metadata to appear on respective images containing alpha-numeric information pertaining to respective programs associated with the images responsive to a determination that a person has tapped a first tap the display.

If desired, the processor enlarges an image responsive to a determination that a person has entered a second tap on the image after the first tap. The processor may also present additional metadata responsive to a determination that a person has entered a second tap on the image. In some examples, responsive to a determination that a person has made a motion against the display in an area occupied by the first image in the second linear dimension the processor animates the first image to rotate and to move translationally along the second dimension while rotating.

In some embodiments, the IBPG includes a share selector selectable to cause a share window to appear on the IBPG. The share window enables a user to enter a comment and to select a social networking site on which to share the comment.

If desired, an image in the IBPG represents an advertisement, and the image is established in the IBPG based at least in part on past user history in selecting the advertisement. In other examples, an image in the IBPG represents an advertisement, and the image is established in the IBPG based at least in part on recommendations pertaining to the advertisement on a social network associated with a user of the device, and/or based at least in part on a general popularity metric of the advertisement, and/or based at least in part a contractual relationship between an entity affiliated with the advertisement and a manufacturer of the device.

In another aspect, a method includes presenting a scrollable arrangement of images on a display of a device. The images establish an image-based program guide (IBPG) on the display, and represent respective channels in an electronic program guide (EPG) from a TV signal provider. Channels are selected for inclusion on the IBPG based on preference information of a user of the device and/or information pertaining to preferences of friends of the user on social networking sites. Typically, the IBPG contains fewer programs than the EPG. Responsive to selection of a first image, a display device is commanded to present an audio video (AV) program associated with the first image.

In another aspect, a control device has a processor, a touch sensitive display controlled by the processor, and a wireless transmitter communicating with the processor. The processor is programmed with instructions to present a scrollable image-based program guide (IBPG) on the display that a user can swipe to cause the processor to command, using the wireless transmitter, a display device to present an audio video (AV) program represented by an image swiped by the user. The IBPG is a subset of an electronic program guide (EPG) from a TV signal provider, and is populated using user history and favorites information and social networking site history and favorites information.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIGS. 2-10 are screen shots illustrating various example aspects of the image-based program guide;

FIGS. 11-14 are flow charts illustrating an example method for generating the image-based program guide; and

FIG. 15 is a flow chart illustrating an example method for generating advertisements on the image-based program guide.

### DETAILED DESCRIPTION OF THE PREFERRED EMBODIMENT

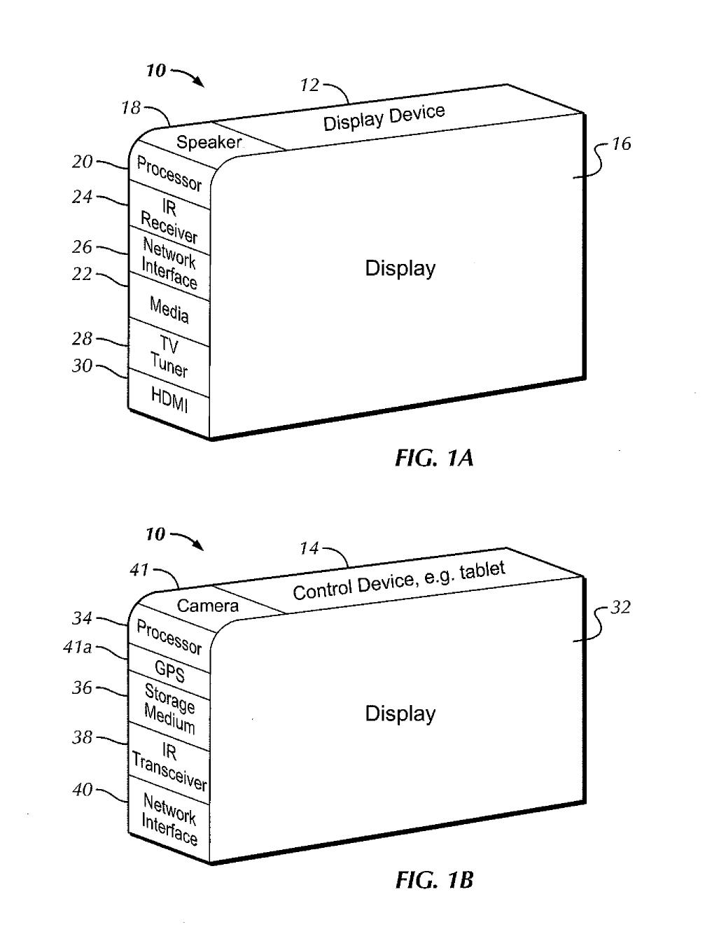

Referring initially to the non-limiting example embodiment shown in FIG. 1, a system is shown, generally designated 10, which includes a display device 12 such as but not limited to TV and a control device 14 such as but not limited to a tablet computer. Other control devices may be used such as but not limited to smart phones, personal computers, personal digital assistants, game consoles, and the like, and other display devices may be used such as but not limited home theater systems. Note that while the example in FIG. 1 illustrates a control device 14 for presenting an image-based program guide for controlling presentation of content presented on a display device 12, in other implementations the content may be presented on the control device 14 without necessarily controlling a display device, and/or the image-based program guide (IBPG) may be presented on the display device 12 which may have, e.g., a touch screen display.

In the example shown for illustration, the display device 12 includes a video display 16 such as a standard definition (SD) or high definition (HD) matrix display. The display device 12 may also have one or more audio speakers 18, with the content output on the display 16 and speakers 18 typically being controlled by a processor or processors 20 accessing one or more computer readable storage media 22 such as but not limited to solid state storage, disk storage, and the like. The processor may receive volume commands, channel commands, trick play commands, tuning commands, input source commands, and the like via an infrared (IR) receiver 24, and may communicate with a wide area network such as the Internet or local area network via a network interface 26 such as a wired or wireless modem. When the display device 12 is a TV it typically includes a TV tuner 28 communicating with the processor 20. When the display 16 is a HD display the display device 12 may include HD multimedia interfaces (HDMI) 30 communicating with respective sources of audio video (AV) content such as game consoles, disk players, personal video recorders, and the like for receiving respective content therefrom.

The control device 14 includes a video display 32 such as a touch screen display. While a touch screen display is envisioned in the non-limiting example shown as the input device for disclosure purposes, other input devices may be used, e.g., keyboards, keypads, point-and-click devices, voice recognition software, etc. The control device 14 may also have one or more processor or processors 34 accessing one or more computer readable storage media 36 such as but not limited to solid state storage, disk storage, and the like. The processor may send commands to the display device 12 via an infrared (IR) transceiver 38, and may communicate with a wide area network such as the Internet or local area network via a network interface 40 such as a wired or wireless modem. An imaging device 41 such as a camera may be mounted on the control device 14 to communicate image signals to the processor 34. Also, a position receiver 41A such as a global positioning satellite (GPS) receiver may receive position information and communicate it to the processor 34.

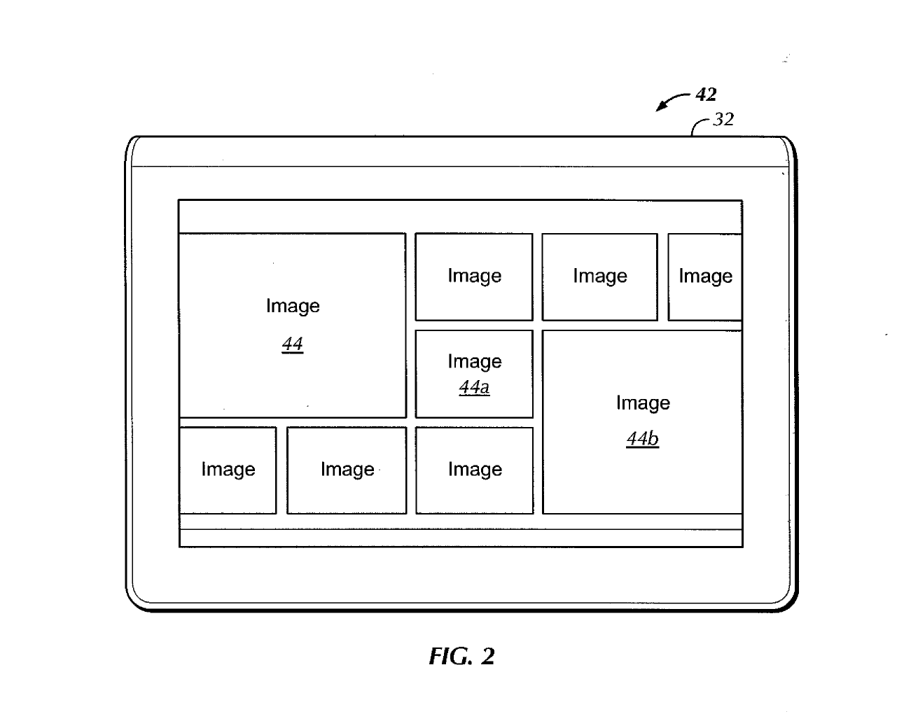

FIGS. 2-9 show various aspects of an IBPG 42. As shown, the IBPG 42 is established by a grid of individual image frames 44 that border each other, most or all of which are photograph-based, e.g., are based on joint photographic experts group (JPEG) images, either real life or cartoon images as shown at 44A. Each image frame may be a rectilinear frame as shown, and as will be discussed further below, some image frames (e.g., 44B) are larger than other image frames (e.g., 44A). Each image frame is selectable to cause the control device 14 and/or display device 12 to present respective audio video (AV) content from a source such as a TV channel that is associated with the selected frame. Typically, the AV content is from a TV signal source such as but not limited to a terrestrial broadcaster, satellite source, cable source and the like, it being understood that some of the AV content may be sourced from, e.g., the Internet, a peer device, a social networking site, and the like. In any case, if desired, the IBPG 42 does not include alpha-numeric indications of a TV channel source for the underlying AV program, unlike conventional EPGs, but only a pictoral image representing the AV program/channel.

In one implementation, the image frames 44 scroll as a unit across the display 32 continuously, for example right to left, absent user intervention in an endless carousel-like loop. As also discussed further below, the number of image frames (and, hence, number of channels selectable using the IBPG 42) is less than the number of channels on an electronic program guide (EPG) from which the IBPG 42 is derived, and may be user-selectable, e.g., the number of frames may be limited to fifty, one hundred, or some other user-defined number, and/or the number of frames may be limited to represented a subset of channels in a spectrum, e.g., limited to only channel numbers 2-100, or 101-200, and so on.

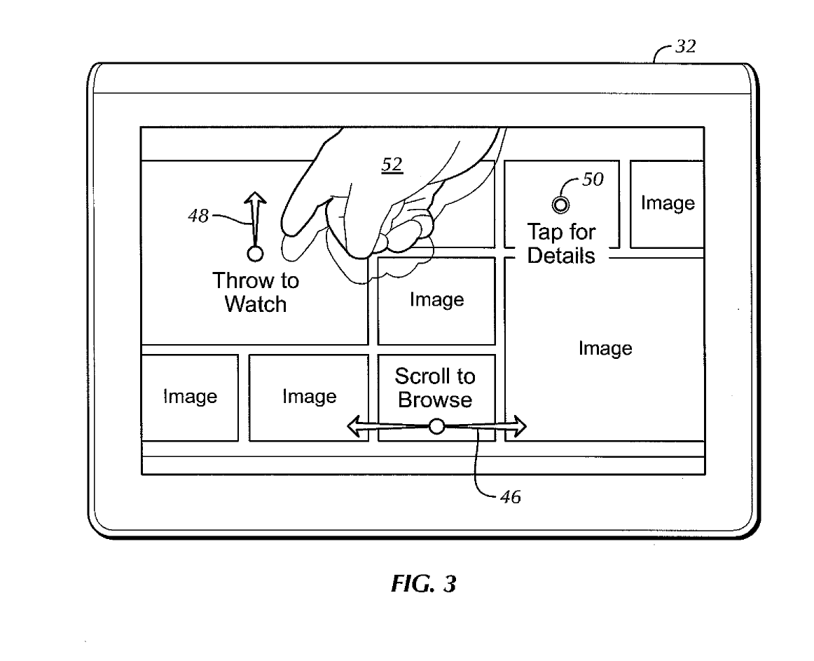

FIG. 3 illustrates various touch gestures against the touch screen display 32 that may be used for example commands when the input device is the touch screen. As shown by the double arrows 46, hand or finger motion against the display 32 in a first dimension, in this case, in the left-to-right dimension relative to a user looking down on the display 32, causes the IBPG 42 to scroll left (when hand motion is to the left) and right (when hand motion is to the right). The speed of scrolling may be proportional to the speed of the hand stroke.

On the other hand, as shown by the arrow 48, a hand gesture from bottom to top of the display 32 may be used to “throw” an image frame 44 to the display device 12, it being readily appreciated that the gesture is hand motion away from the user as if tossing an object. What this means is that the control device processor 34 interprets the gesture represented by the arrow 48 to mean “play the underlying video” associated with the image frame 44 over which the user made the gesture. In response, the control device 14 sends a wireless (e.g., IR) command signal to the display device 12 to immediately tune to the source of the AV content associated with the image frame 44 over which the user made the gesture and play the content.

Note that a user may make the throw gesture over multiple image frames 44. In this case, the control device 14 signals to the display device 12 to simultaneously present the respective AV content in split screen or picture-in-picture format on the display device 12.

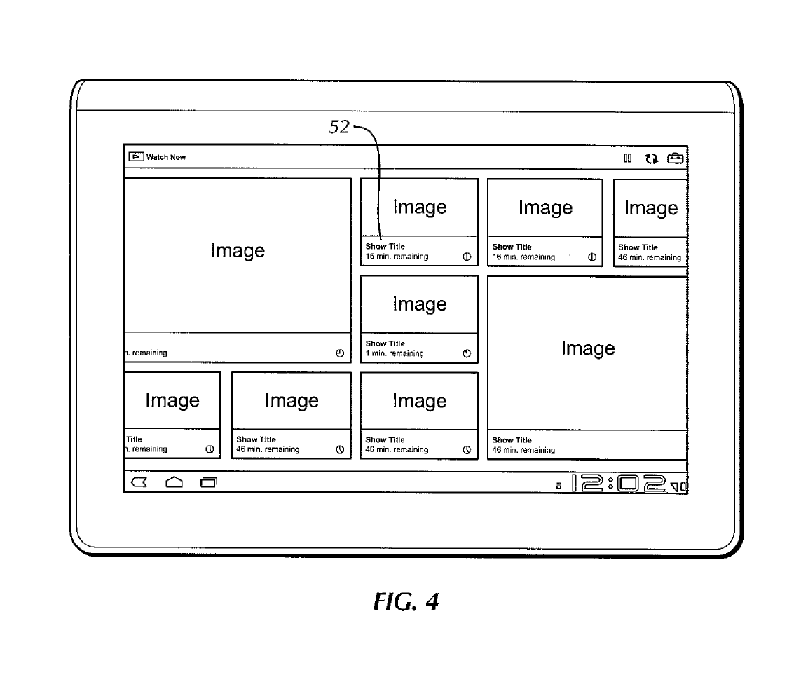

Yet again, as indicated by the dot 50, a tap (without translational motion) on the display 32 indicates to the processor 34 to overlay metadata onto the image frames 44 to render the display shown in FIG. 4. Note that the arrows 46, 48, dot 50, hand image 52, and corresponding alphabetic instructions under the arrows and dot may actually be shown on the display 32, e.g., the first time after powering up subsequent to purchase, to inform the viewer as to what gestures should be used for what commands.

Turning to FIG. 4, responsive to a single press, as shown at 52 metadata appears on each image 44 indicating the title and time remaining for each respective video represented by an image frame 44. After a predetermined period since the single press, the metadata 52 may fade from view, resuming the appearance of the IBPG shown in FIG. 2.

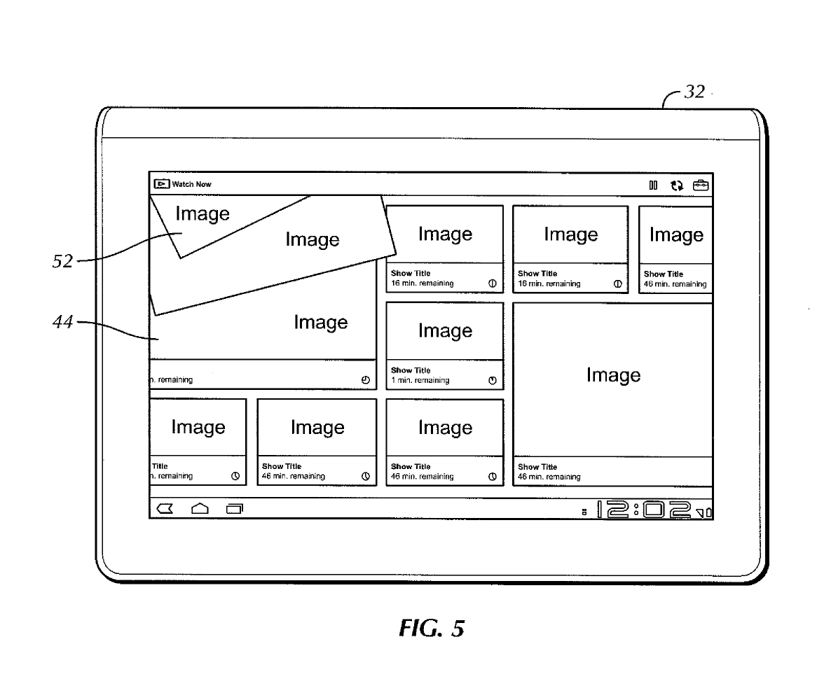

Recall that the “throw” gesture results in the control device 14 commanding the display device 12 to present an AV program associated with the “thrown” image frame 44. FIG. 5 illustrates that in addition, responsive to a “throw” gesture the control device 14 can present an animation of the thrown image frame 44 as indicated at 54. In the example shown, the thrown image frame 44 is caused to rotate on an imaginary left-to-right axis while it translating upwardly on the display 32.

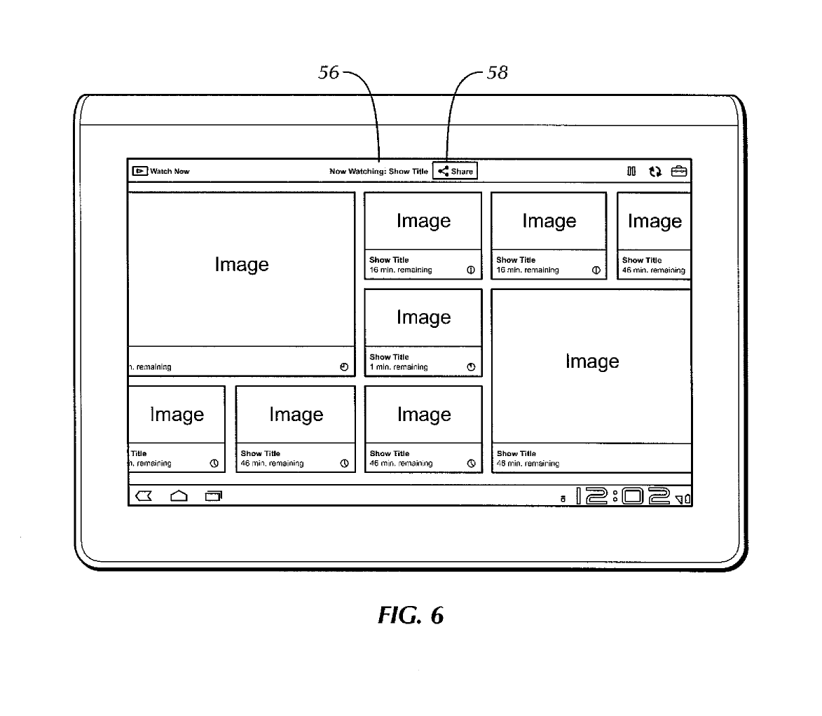

Still further, after the command is sent to the display device 12 and the thrown image frame 44 animation has been executed, FIG. 6 shows that the IBPG then indicates by a “now watching” message 56 that the display device 12 has been commanded to play the AV content associated with the “thrown” image frame 44. Additionally, a share selector 58 appears which can be selected to share the “thrown” program on social networking computer sites.

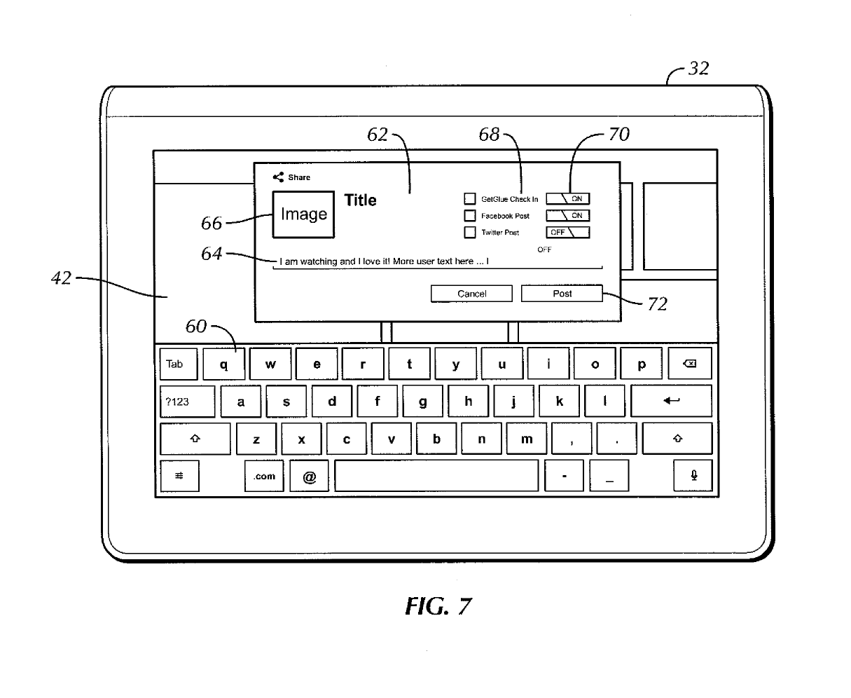

FIG. 7 shows the results in one embodiment of selecting the share selector 58. The image frames 44 of the IBPG 42 are grayed down (but still visible), and an image 60 of an input device such as a keyboard is overlaid on the IBPG 42. A user can enter alpha numeric characters by touching the display 32 at the locations over which the desired keys of the image 60 are overlaid.

Moreover, a share window 62 is overlaid on the grayed down IBPG 42. Text entered by means of the input device image 60 is entered in a text entry area 64 of the share window 62. The share window 62 also contains a miniature image 66 of the thrown image frame 44.

To enable the user to select people with whom to share the entered text and if desired miniature image of the thrown program, a list 68 of social networking sites may be presented along with respective toggle indicators 70 enabling a user to select (“on”) or deselect (“off”) by touching the indicators. When a post selector 72 is selected, the user's comments in the text entry area 64 are sent to the user's friends on the selected networking sites. To this end, it will readily be appreciated that the control device processor 34 accesses the user's various social networking friends lists, typically stored on the storage medium 36.

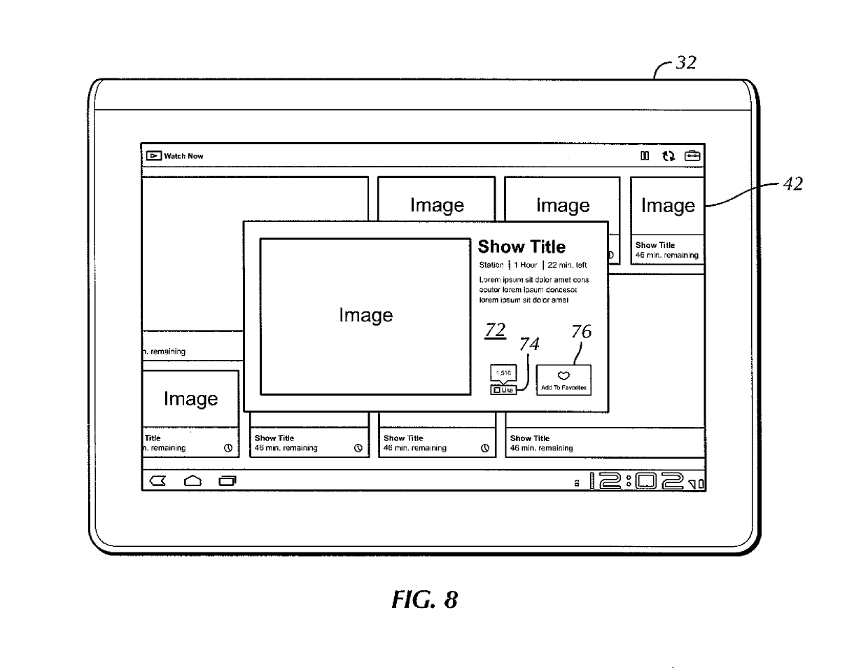

Responsive to a second tap on an image frame 44 or other signal, as shown in FIG. 8 the IBPG is once again grayed down and an additional program information window 72 is superimposed over the IBPG. As shown, the additional program information window 72 includes further details beyond the metadata 52 shown in FIG. 4, in the example shown, a show summary and an indication of which network the show has been selected on. Moreover, a “like” selector 74 appears on the example additional program information window 72 which can be selected to indicate that the user likes the program. An indication may also be provided as shown indicating how many other people input “like” recommendations.

Additionally, a favorites selector element 76 may be presented on the additional program information window 72. Selecting this element 76 causes the channel represented by the selected image frame 44 to be added to a favorites data structure stored in, e.g., the memory 36.

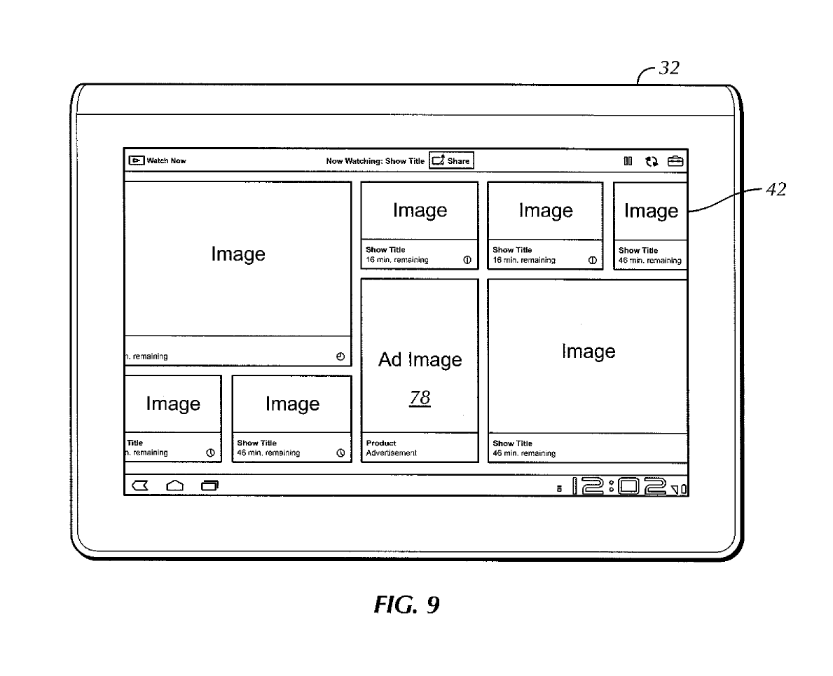

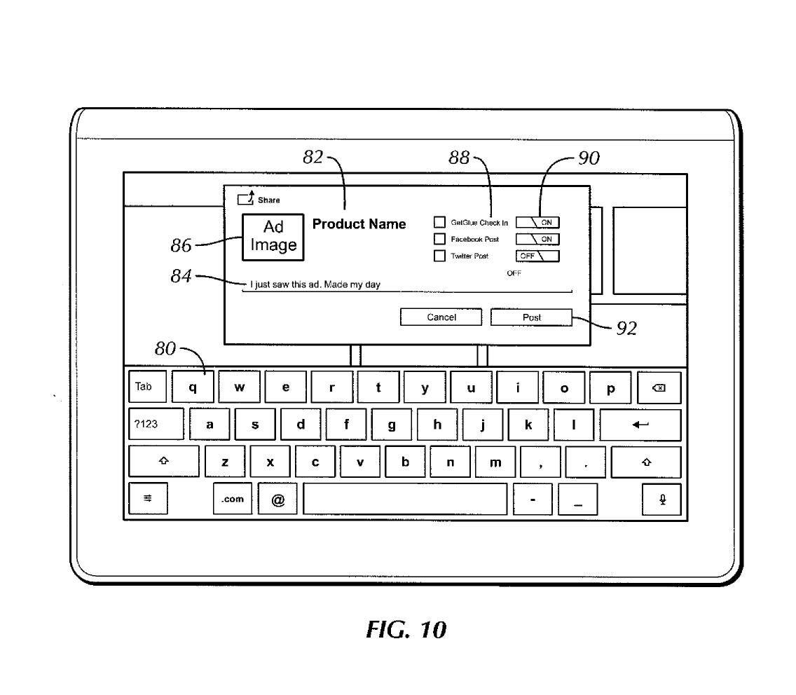

In addition to image frames 44 representing AV programs such as TV channel programs, FIGS. 9 and 10 show that one or more advertisement frames 78 may be included in the IBPG 42. Further description below explains how the advertisements are selected for population into the IBPG. Selecting the advertisement frame 78 shown in FIG. 9 causes the IBPG 42 to be grayed down as shown in FIG. 10 and an image 80 of an input device such as a keyboard to appear by means of which a user can input comments along the lines discussed above into an advertisement window 82, also overlaid on the grayed down IBPG.

Text entered by means of the input device image 80 is entered in a text entry area 84 of the window 82. The window 82 also contains a miniature image 86 of the selected advertisement.

To enable the user to select people with whom to share the entered text and if desired miniature image of the advertisement, a list 88 of social networking sites may be presented along with respective toggle indicators 90 enabling a user to select (“on”) or deselect (“off”) by touching the indicators. When a post selector 92 is selected, the user's comments in the text entry area 84 are sent to the user's friends on the selected networking sites. To this end, it will readily be appreciated that the control device processor 34 accesses the user's various social networking friends lists, typically stored on the storage medium 36.

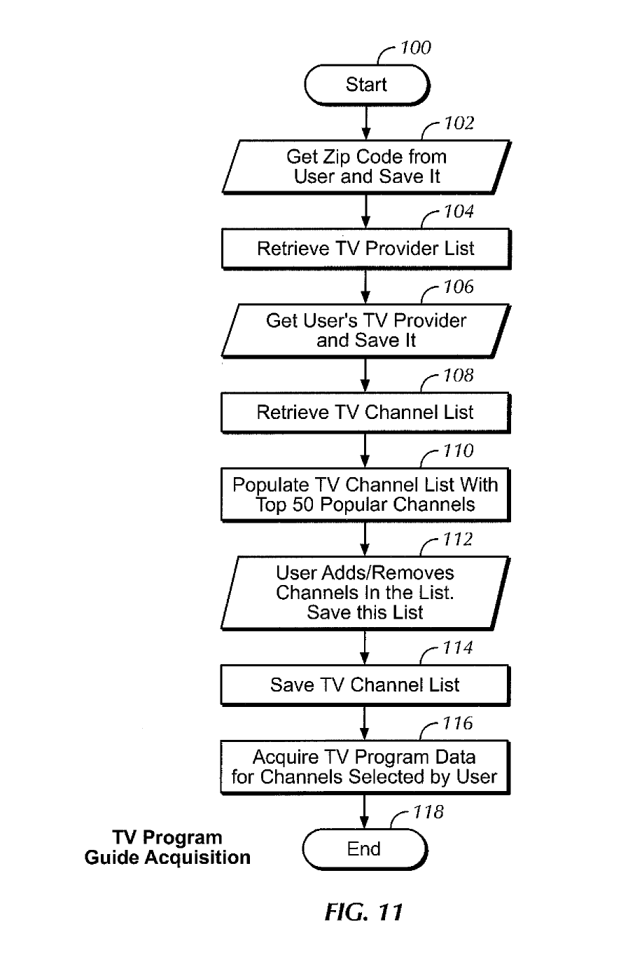

Now referring to FIGS. 11-14 for explanation of one example embodiment for how the control device 14 populates the IBPG 42, starting at state 100 the logic executed by the processor 34 moves to state 102 to obtain geographic location information of the control device 14. In one example, this is done by presenting a prompt on the display 32 for the user to enter his postal code. In other examples, location information may be retrieved from the position receiver 41A and correlated to a zip code.

In any case, once the user's location is known, at state 104 the user's TV provider list for the user's location is obtained, e.g., over the Internet, and then at state 106, the list is saved. At state 108 the electronic program guide (EPG) of the TV provider is obtained, either over the Internet or over a TV EPG channel source.

Moving to block 110, the IBPG 42 is populated with a subset of less than all of the channels on the EPG. In one implementation, the IBPG is populated with the N most popular channels according to disclosure below, wherein N is a default and/or user-selected integer, e.g., fifty (50). As indicated above, however, if the user elects to populate the IBGT with a group of channels from the EPG, e.g., only channel numbers 1-100, then that group of channels establishes the IBPG.

At block 112, the user is allowed to remove channels in the list. This may be effected in a number of ways. For instance, a setup menu may present an alpha-numeric list of the channels in the IBPG from which the user can select to prune a channel.

The list is then saved at state 114. Next, at block 116 program data is acquired for each of the remaining channels on the IBPG. The logic ends at state 118.

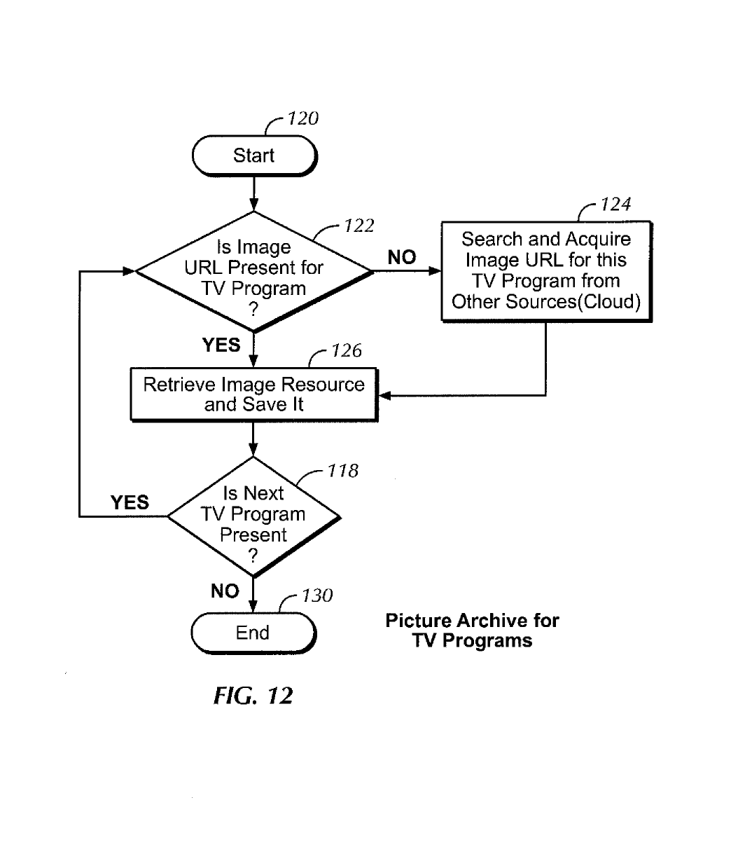

Starting at state 120 in FIG. 12, the logic moves to decision diamond 122 to determine, for a first channel in the IBPG, whether an associated image is present in storage 36 to establish the corresponding image frame 44 of the IBPG. If it is not, the logic moves to block 124 to search for an image for the current program on the channel under test. This may be executed by the processor 34 accessing a search engine on the Internet and entering a search term that can include, e.g., the channel name and number and program name. An image returned by the search, typically the first image in the search results since it is likeliest to be most relevant, is obtained and saved locally at block 126. In the event that an image already exists in local storage for the channel under test that image is simply indicated as being the image to use for the corresponding image frame 44 of the IBPG. It is then determined at decision diamond 128 whether an additional channel in the IBPG requires testing for an image and if so the logic loops back to decision diamond 122. Otherwise, the logic ends at state 130.

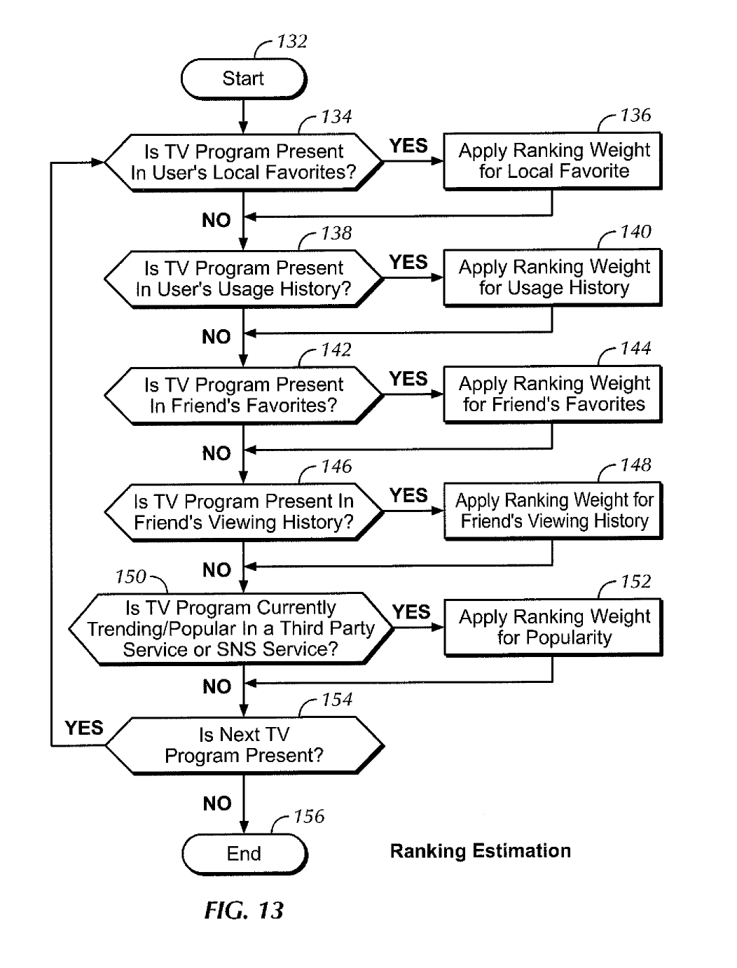

FIG. 13 illustrates the logic for weighting the programs on the EPG in deriving the IBPG. Commencing at start state 132, the logic moves to decision diamond 134 to determine whether the program/channel under test has been previously designated as a user favorite. Responsive to a determination that it has, the logic moves to block 140 to apply a user favorites weight to the program/channel. From block 140 or from decision diamond 134 if the test there was negative, the logic flows to decision diamond 138.

At decision diamond 138, the logic determines whether the program/channel under test is present in a user history data structure. Channels/programs may be added to the user history data structure if, for example, the channel/program has been tuned to in the past X hours a predetermined number N times, where X and N are integers that may be default numbers and/or user-selected numbers entered by means of a setup menu. Responsive to a determination that the program/channel is in the user history data structure, the logic moves to block 140 to apply a user history weight to the program/channel. From block 140 or from decision diamond 138 if the test there was negative, the logic flows to decision diamond 142.

At decision diamond 142, the processor 34 executing the logic determines whether the program/channel under test has been previously designated as a friend favorite. This may be done by accessing a social networking friend database in the memory 36 or over the Internet to determine if any of the user's social networking friends has designated the channel/program a “favorite”. Responsive to a determination that it has, the logic moves to block 144 to apply a friend favorites weight to the program/channel. From block 144 or from decision diamond 142 if the test there was negative, the logic flows to decision diamond 146.

At decision diamond 146, the logic determines whether the program/channel under test is present in a friend history data structure. Channels/programs may be added to the friend history data structure if, for example, the channel/program has been tuned to in the past X hours a predetermined number N times by a friend on a social networking site, where X and N are integers that may be default numbers and/or user-selected numbers entered by means of a setup menu. Responsive to a determination that the program/channel is in the friend history data structure, the logic moves to block 148 to apply a friend history weight to the program/channel. From block 148 or from decision diamond 146 if the test there was negative, the logic flows to decision diamond 150.

At decision diamond 150, the logic determines whether the program/channel under test is trending positive on, e.g., a third party rating service available over the Internet or on a social networking site as indicated by the number of “likes” accorded the program/channel. A threshold may be used, e.g., over 100 likes or over ten likes in the past hour, for example, could result in a positive test at diamond 150. Responsive to a determination that the program/channel is popular, the logic moves to block 152 to apply a popularity weight to the program/channel. From block 152 or from decision diamond 150 if the test there was negative, the logic flows to decision diamond 154, where it is determined whether additional programs/channels in the EPG require testing. If so, the next channel is tested by looping back to decision diamond 134. Otherwise, the logic ends at state 156.

It is to be noted that the above weighting may be effected in one of plural ways. In one example, the weights may be different from each other, and/or some weights may be the same as other weights but different from yet other weights. The weights may be additive or, to give even greater importance to a channel/program satisfying multiple weighting criteria, multiplicative.

For example, assume each channel/program starts with a weight of one, which is then multiplied by any weight for which the channel/program has satisfied the respective testing condition to yield a product. Assume that the channel/program satisfies a first condition whose weight is two and a second condition whose weight is three. The resulting products may be added together to arrive at a total weight of five. Or, the resulting products may be multiplied together to arrive at a total weight of six. Note further that instead of weights which result in higher scores, with the top N scoring programs being selected for the IBPG, the inverse concept may be used, i.e., weights whose tests are satisfied can result in lower scores with the bottom N scoring programs being selected for the IBPG.

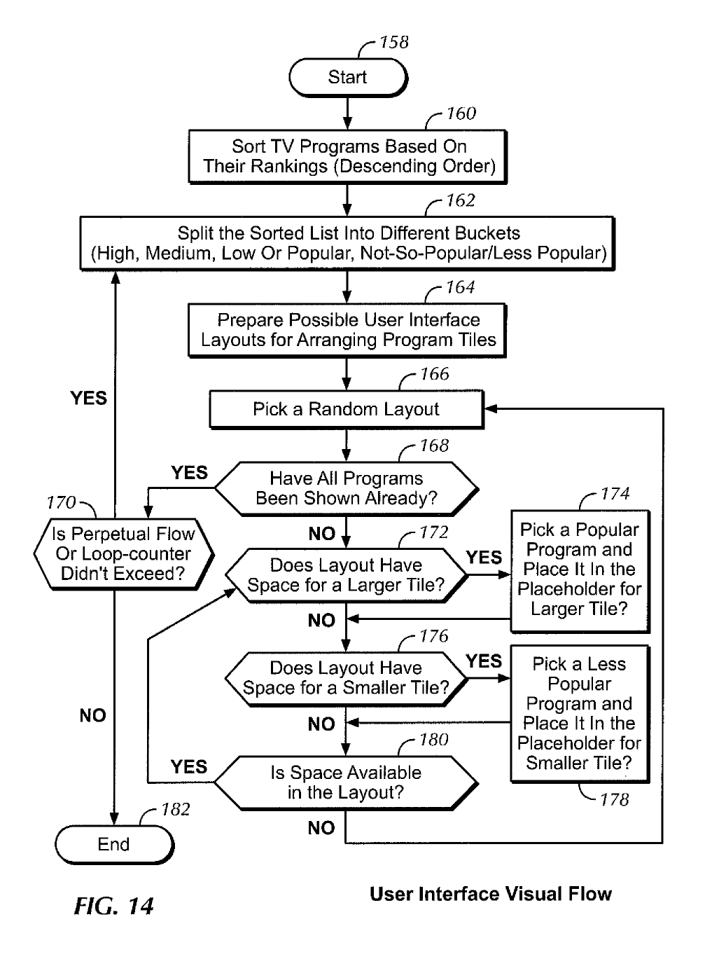

Once the channels/programs in the EPG have been weighted according to FIG. 13, the logic of FIG. 14 starts at state 158 and proceeds to block 160 to sort the programs in order by their total respective weights. If desired, at block 162 the sorted list may be split into segments of most popular (by weight), next most popular, and so on. Then, at block 164 possible layouts, including differing sizes, for the N image frames 44 that constitute the IBPG are generated. This may be done a priori, i.e., multiple layouts may be predefined by the supplier of the control device 14 and stored in memory 36. Or, the processor may simply generate multiple layouts of “N” image frames within certain predefined constraints, e.g., only X % are large, only three rows of smaller frames are permitted, etc.

One of the layouts is selected at random at block 166 and then at decision diamond 168 it is determined whether all programs have been shown already. If so, the logic moves to decision diamond 170 to determine whether a perpetual flow or loop counter has been exceeded and if so the logic ends at state 182. Otherwise, the logic loops back to block 162.

On the other hand, when it is determined at decision diamond 168 that not all the programs have been shown already, the logic moves to decision diamond 172 to determined whether the selected IBPG layout has a space allocated for a larger image frame. If so, one of the programs in the “most popular” segment is selected and its corresponding image frame inserted into the space at block 174.

From block 174 or from decision diamond 172 if the test there was negative, the logic moves to decision diamond 176 to determine whether the selected IBPG layout has a space allocated for a smaller image frame. If so, one of the programs in the “less popular” segment is selected and its corresponding image frame inserted into the space at block 178.

From block 178 or from decision diamond 176 if the test there was negative, the logic moves to decision diamond 180 to determine whether any unfilled spaces exist in the selected IBPG layout. If so, the logic loops back to decision diamond 172, but if not the logic ends at state 182.

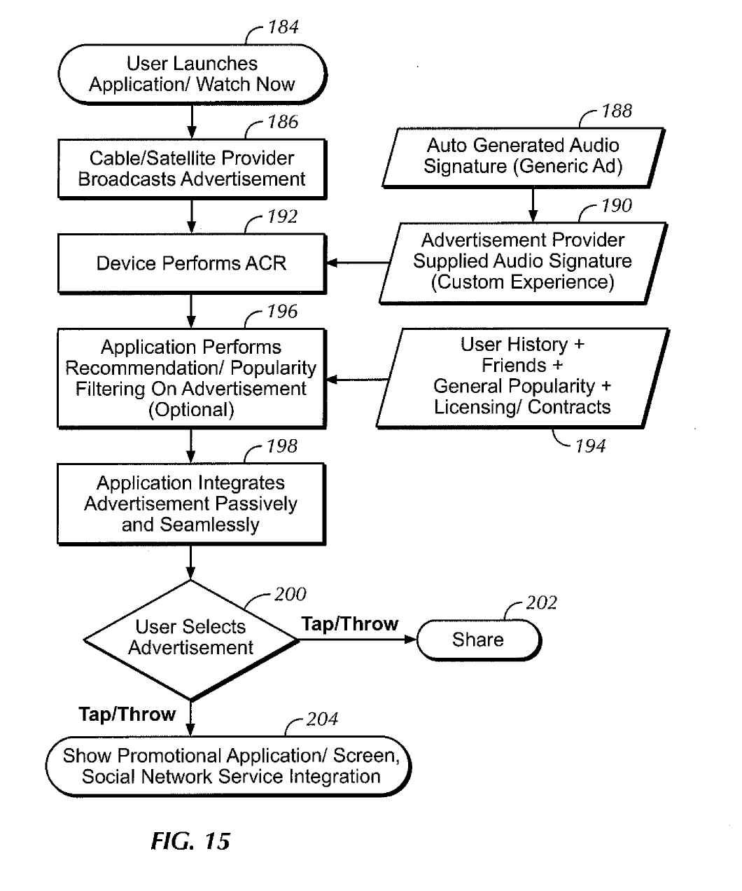

FIG. 15 illustrates that similar considerations may be applied in selecting advertisements for the IBPG 42. Upon the user launching the IBPG application at state 184 advertisements are received from, e.g., TV signal providers at state 186. Also, generic audio signatures are generated at state 188 for each ad, typically by an ad provider, and at state 190 an additional customized audio signature may also be generated. These signatures are combined so that at state 192 the processor 34 can compare a decoded audio signature from a received ad with the audio signatures from states 188 and 190 to perform ad recognition.

Additionally, at state 194 user history with the particular ad under test, friends' recommendations from social networking sites pertaining to the ad, general popularity of the ad as indicated by the number of likes, for example, on a social networking site, and licensing or contractual arrangements between ad providers and the manufacturer of the control device 14 are obtained. A subset of these may be used. These are then used at block 196 to filter ads by popularity, etc. For example, each ad may be accorded a weight for each of the criteria in block 194 it satisfies similar to the logic for weighting channel/program described above, and only ads satisfying a threshold weight may be passed through the filter of state 196.

At state 198 the selected ads are then added to the IBPG seamlessly and transparently to the user to arrive at the example screen shot of FIG. 9. If it is determined at decision diamond 200 that a user has selected an ad from the IBPG, it may be shared at state 202 according to description above. Or, at state 204 a promotional application or social network integration presentation may be displayed.

It may now be appreciated that the IBPG can be continuously updated according to the logic above and may present image frames representing multiple content types. Note that the direction of automatic scrolling of the IBPG may be different for different devices, e.g., the IBPG may scroll left to right on some devices such as a tablet computer and from bottom to top on other devices such as a smart phone. The sizes of the image frames 44 may be based on relevance and/or popularity, and a user can customize channels/favorites. Animation may be used as described.

If desired, three dimensional scrolling may be used, e.g., in the embodiment described the IBPG may scroll in time in the z-axis. Progressive disclosure of program details is afforded by the above description. Trusted social networking site check-in in the form of accessing known friends lists while sharing as described is effected. The image frames 44 may be real-time images of TV shows and of real-time ads. Because of the graphical nature of the IBPG, there is no need to remember channel numbers to tune to a desired show. If desired, the camera 41A may be used to effect user face recognition to establish an IBPG tailored for that user, and/or to effect room recognition or nearby device logo recognition to present an IBPG tailored for the recognized location.

Multiple sources may be used for alternate image frames 44. Only the top “N” (e.g., 50) channels by weight from the EPG may be used to populate the IBPG, channels may be grouped by number (1-100, 101-200, etc.) to establish the IBPG. The IBPG may include various media types, including TV Shows, live TV, movies, music, books, and games, all of which may be weighted for inclusion on the IBPG as described above.

In weighting a channel/program for inclusion on the IBPG, the following criteria may be used: local favorites, usage history, user's social networking site likes, friend's social networking site likes, user's viewing activity, friend's viewing activity.

Popularity/trending information may be provided by 3^{rd} party providers, social networking sites (indicated by, e.g., “likes” count, number of followers of a page, check-in count, or a talking_about_count of a particular social networking site.

In some implementations the user's viewing history, e.g., how long a viewer watched a show, can be recorded and a graphic representative thereof presented upon user command. A playlist of TV shows may be queued and liked/similar shows used in preparing the queue, essentially a recommendation engine for recommending future shows based on shows currently in the IBPG.

With further respect to the ad-related logic of FIG. 15, an audio signature is constructed for each advertisement. This signature uniquely identifies the advertisement and allows an application to provide a customized experience for each advertisement. These signatures can be pre-processed by a cloud service or issued by an advertisement provider. The logic collects advertisement information as it relates to the user. This data includes usage history, social network ratings, social network friend ratings, general popularity and possible licensing agreements between device 14 manufacturer and advertisement providers. All information is collected using web service APIs and data logs stored on the local device. Using customizable weighting values for each filter the logic can determine how to display the advertisement, including duration on screen, location on screen, size of image if available, and size of text if available. The logic then determines how to display the results from recognition and recommendation/popularity filtering allowing for many custom UI solutions supporting a single advertisement recognition/filtering library.

Furthermore, the application/advertisement provider can determine what must be done when user interacts with an ad. For example, the user can throw the ad to friend, “like” and/or rate and ad and/or ad provider, and if an ad is for a game, a connection may be established with a social networking friend device to play the game with a friend.

If desired, a software development kit may be published so that additional parties may develop their own advertisement based applications. Crowd-sourcing may be used in which the community is used to generate better deals/promotions from advertisers. Incentives for sharing with friends may be provided. Inline ads spawned from TV/movie scenes may be used.

While the particular INTUITIVE IMAGE-BASED PROGRAM GUIDE FOR CONTROLLING DISPLAY DEVICE SUCH AS A TELEVISION is herein shown and described in detail, it is to be understood that the subject matter which is encompassed by the present invention is limited only by the claims.

1. A device comprising:
at least one display;
at least one processor controlling the display to present an image-based program guide (IBPG) on the display;
computer readable storage medium accessible to the processor and bearing instructions executable by the processor to cause the processor to generate a channel list by:
testing channels in an electronic program guide (EPG) from a TV signal provider to determine whether channels in the EPG are identified in a local favorite's list;
responsive to a determination that a channel in the EPG is in the local favorite's list, applying a favorites weight to the channel;
responsive to a determination that a channel in the EPG is present in a local history list of previously viewed channels, applying a history weight to the channel;
responsive to a determination that a channel in the EPG is in a favorite's list of a social networking friend affiliated with a user of the device, applying a friend's favorite weight to the channel;
responsive to a determination that a channel in the EPG is present in a history list of previously viewed channels of a social networking friend affiliated with a user of the device, applying a friend's history weight to the channel;
establishing the channel list based at least in part on the weights, the channel list being a subset of less than all of the channels on the EPG; and
for each channel, establishing a respective photograph-based image and arranging the images in the IBPG, each image being selectable to cause an AV program associated with the respective channel to be presented on a display device.

2. The device of claim 1, wherein the device is a control device different from the display device, the control device communicating wirelessly with the display device.

3. The device of claim 1, wherein a first image has a first size and a second image has a second size different from the first size, and the sizes are established based at least in part on one or more of the weights.

4. The device of claim 1, wherein a first image has a first size and a second image has a second size different from the first size, and the sizes are established based at least in part on all of the weights.

5. The device of claim 1, wherein the images of the IBPG scroll across the display automatically.

6. The device of claim 1, wherein the display is a touch screen display and the processor causes the images of the IBPG to scroll across the display responsive to a determination that a person has made a motion against the display in a first linear dimension.

7. The device of claim 6, wherein the processor causes a command to be sent to another device to present an AV program affiliated with a first image of the IBPG responsive to a determination that a person has made a motion against the display in an area occupied by the first image in a second linear dimension different from the first linear dimension.

8. The device of claim 6, wherein the processor causes metadata to appear on respective images containing alpha-numeric information pertaining to respective programs associated with the images responsive to a determination that a person has tapped a first tap the display.

9. The device of claim 8, wherein the processor enlarges an image responsive to a determination that a person has entered a second tap on the image after the first tap, the processor also presenting additional metadata responsive to a determination that a person has entered a second tap on the image.

10. The device of claim 7, wherein responsive to a determination that a person has made a motion against the display in an area occupied by the first image in the second linear dimension the processor animates the first image to rotate and to move translationally along the second dimension while rotating.

11. The device of claim 1, wherein the IBPG includes a share selector selectable to cause a share window to appear on the IBPG, the share window enabling a user to enter a comment and to select a social networking site on which to share the comment.

12. The device of claim 1, wherein at least one image in the IBPG represents an advertisement, and the image is established in the IBPG based at least in part on past user history in selecting the advertisement.

13. The device of claim 1, wherein at least one image in the IBPG represents an advertisement, and the image is established in the IBPG based at least in part on recommendations pertaining to the advertisement on a social network associated with a user of the device.

14. The device of claim 1, wherein at least one image in the IBPG represents an advertisement, and the image is established in the IBPG based at least in part on a general popularity metric of the advertisement.

15. The device of claim 1, wherein at least one image in the IBPG represents an advertisement, and the image is established in the IBPG based at least in part on a contractual relationship between an entity affiliated with the advertisement and a manufacturer of the device.

16. Method, comprising:
presenting a scrollable arrangement of images on a display of a device, the images establishing an image-based program guide (IBPG) on the display;
the images representing respective channels in an electronic program guide (EPG) from a TV signal provider, channels being selected for inclusion on the IBPG based at least in part on preference information of a user of the device and/or information pertaining to preferences of friends of the user on social networking sites, the IBPG containing fewer programs than the EPG; and
responsive to selection of a first image, commanding a display device to present an audio video (AV) program associated with the first image;
wherein the IBPG is at least initially presented prior to receiving user input directed to the IBPG to only present images on the IBPG such that the IBPG does not present alpha-numeric information on portions of the IBPG other than portions on which the images are presented.

17. The method of claim 16, comprising:
determining whether channels in the EPG are identified in a local favorite's list;
responsive to a determination that a channel in the EPG is in the local favorite's list, applying a favorites weight to the channel;
responsive to a determination that a channel in the EPG is present in a local history list of previously viewed channels, applying a history weight to the channel;
responsive to a determination that a channel in the EPG is in a favorite's list of a social networking friend affiliated with a user of the device, applying a friend's favorite weight to the channel;
responsive to a determination that a channel in the EPG is present in a history list of previously viewed channels of a social networking friend affiliated with a user of the device, applying a friend's history weight to the channel;
establishing the channel list based at least in part on the weights, the channel list being a subset of less than all of the channels on the EPG; and
for each channel, establishing a respective photograph-based image and arranging the images in the IBPG, each image being selectable to cause an AV program associated with the respective channel to be presented on a display device.

18. The method of claim 17, wherein a first image has a first size and a second image has a second size different from the first size, and the sizes are established based at least in part on one or more of the weights.

19. The method of claim 16, comprising, responsive to a person having made a linear motion against the display in an area occupied by the first image, animating the first image to rotate and to move translationally while rotating.

20. A control device comprising:
at least one processor;
at least one touch sensitive display controlled by the processor;
at least one wireless transmitter communicating with the processor, wherein the processor is programmed with instructions to:
present a scrollable image-based program guide (IBPG) on the display that a user can swipe to cause the processor to command, using the wireless transmitter, a display device to present an audio video (AV) program represented by an image swiped by the user, the IBPG being a subset of an electronic program guide (EPG) from a TV signal provider, the IBGT being populated using user history and favorites information and social networking site history and favorites information;
wherein the AV program is an AV program provided in a stream by the TV signal provider, and wherein the image representing the AV program changes on the IBPG in real-time as the AV program stream is received from the TV signal provider, the AV program changing in real-time to represent respective portions of the AV program as the portions are received in real time.
